(19) United States
(12) Patent Application Publication
(10) Pub. No.: US 2006/0049652 A1
(43) Pub. Date: Mar. 9, 2006

(54) Automobile alcove apparatus and method of use

(76) Inventor: Patricia A. Martin, Bellevue, WA (US)

Correspondence Address: DAVIS WRIGHT TREMAINE, LLP, 2600 CENTURY SQUARE, 1501 FOURTH AVENUE, SEATTLE, WA, 98101-1688, US

(21) Appl. No.: 10/935,677

(22) Filed: Sep. 7, 2004

(51) Int. Cl. B60P 3/345

(52) U.S. Cl. 296/26.08

(57) ABSTRACT

An automobile alcove designed for installation on a rear lift gate of an automobile includes a top panel whose leading edge is coupled to the automobile. The top panel deploys over the opened lift gate and a rear panel coupled thereto extends downwardly to a location near the ground. Left and right side panels are deployed to complete the enclosure. The left and right side panels are coupled to the top panel using a convenient mechanism, such as a zipper. One or both of the side panels includes a closure mechanism, such as a zipper, to allow entry and exit from the interior portion of the alcove. The top panel may be mechanically or magnetically coupled to the automobile at a leading edge. Edges of the left and right side panels adjacent to the automobile may also be magnetically or mechanically coupled to the automobile to secure the alcove. Fasteners, such as magnets or Velcro aid in the installation and/or removal of the alcove. The left and right side panels may be folded towards the rear panel and magnetically coupled thereto during the removal process. The rear panel and folded side panels may be rolled up and secured with straps.

### BACKGROUND OF THE INVENTION

1. Field of the Invention

The present invention is directed generally to a shelter for use with an automobile and, more particularly, to an automobile alcove apparatus and method of use.

2. Description of the Related Art

Automobiles have been used for decades for a variety of purposes beyond simply providing basic transportation needs. For example, vans have been adapted with a pop-up roof to form a tent-like device to permit camping. Other vehicles are adapted to have tents or shelters that attach to the side of the van.

Although each of these shelter adaptations serve a useful purpose, there are still are shortcomings with the known technology. For example, the pop-up roof provides additional headroom, but does not provide a convenient area for changing clothes. If the users have wet clothes, it becomes necessary to enter the vehicle in the wet clothing. The tent device that attaches to the side of a van may provide an external changing area, but is difficult to set up and requires tent poles and stakes for structural stability. This precludes its use as a quick changing area.

Therefore, it can be appreciated that there is a significant need for an alcove or changing area for use with an automobile. The present invention provides this and other advantages as will be apparent from the following detailed description and accompanying figures.

### BRIEF SUMMARY OF THE INVENTION

In an exemplary embodiment, the present invention is embodied in an automobile alcove apparatus designed for attachment to an automobile and supported by a rear lift gate of the automobile. The apparatus comprises a top panel having a first edge for removable attachment to the automobile with the top panel extending in a first direction approximately the width of the lift gate and extending in a second direction approximately equal to a distance between a pivotally mounted end portion of the lift gate and a free end portion of the lift gate. A rear panel is coupled with the top panel at a second edge opposite the first edge and extends downwardly to a location proximate the ground. The apparatus further comprises first and second opposing side panels each coupled to the top panel and the rear panel and a coupling member coupled to the top panel first edge and configured to be removably coupled to the automobile in an area proximate the lift gate of the automobile.

In one embodiment, the coupling member may be a magnetic strip coupled to the first edge and positioned for magnetic coupling to the automobile. Alternatively, the coupling member may comprise a Velcro attachment member coupled to the first edge, an elastic member coupled to the first edge for resilient coupling to the automobile, a snap member coupled to the first edge for attachment to the automobile, a rod member fixedly coupled to the first edge and positioned for mechanical attachment to the automobile, or straps coupled to the first edge and having a length sufficient to attach to the automobile.

The apparatus may further comprise an adjustment mechanism coupled to the top of the panel and configured for adjustment by the user to adjust the top panel at least in the first direction to adjust to the width of the lift gate. In one embodiment, the adjustment mechanism may comprise a resilient member coupled to the top panel and adjustable by the user. Alternatively, the adjustment mechanism may comprise a drawstring coupled to the top panel and adjustable by the user. In yet another embodiment, the apparatus further comprises a resilient member coupled to at least a portion of a perimeter of the top panel to permit the top panel to fit the lift gate.

In another exemplary embodiment, the apparatus further comprises a closure mechanism coupling the rear panel to a selected one of the first and second side panels. In one embodiment, the closure mechanism may be a zipper. Alternatively, the closure mechanism may comprise magnetic coupling elements, Velcro elements, or strap elements.

In another exemplary embodiment, the apparatus may further comprise attachment members on the first and second side panels along an edge of the side panels adjacent the automobile to removably couple the adjacent edge of the first and second side panels to the automobile. In one embodiment, the attachment members on the first and second side panels may be magnetic members positioned for magnetic attachment to the automobile. Alternatively, the attachment members for the first and second side panels may be resilient coupling members.

In a further exemplary embodiment, the apparatus may comprise a weighted member attached to the rear panel at a lower end thereof. Alternatively, the lower end of the rear panel may include provisions for stakes to retain the rear panel in position.

In an exemplary embodiment, at least one of the first and the second opposing side panels is coupled to the top panel by a zipper. In an exemplary embodiment, both the first and second side panels may be coupled to the top panel with a zipper. The apparatus may also comprise an adjustment mechanism in addition to, or in place of, the zipper. The adjustment mechanism allows the top panel to be adjusted to accommodate differing widths of the lift gate.

### BRIEF DESCRIPTION OF THE DRAWING(S)

FIG. 1 is a right side (passenger side) perspective view of a rear portion of an automobile with the alcove mounted on the automobile.

FIG. 2 is a left side (driver side) perspective view of a rear portion of an automobile with the alcove mounted on the automobile.

FIG. 3 is a top plan view of the rear portion of an automobile illustrating the mounting of the automobile alcove near the automobile lift gate while the lift gate is in a closed position.

FIG. 4 is a top plan view of the rear portion of an automobile illustrating an alternative coupling mechanism to mount the automobile alcove to the automobile.

FIG. 5 is a top plan view of the rear portion of an automobile illustrating another alternative coupling mechanism to mount the automobile alcove to the automobile.

FIG. 6 is a top plan view of the rear portion of an automobile illustrating the mounting of the automobile alcove near the automobile lift gate while the lift gate is in an open position.

FIG. 7 is a rear perspective view of the automobile alcove mounted on the automobile with the top and rear panels deployed.

FIG. 8 is a right side perspective view of a partially deployed automobile alcove.

FIG. 9 is a right side perspective view with the right side panel deployed.

FIG. 10 is a rear perspective view of the automobile alcove with a side panel opened for ingress or egress.

FIG. 11 is a right side perspective view illustrating an adjustment mechanism for the top panel.

### DETAILED DESCRIPTION OF THE INVENTION

As will be discussed in greater detail herein, an automobile alcove apparatus, supported by a raised rear lift gate of an automobile, may be easily assembled and disassembled. The term “automobile” is intended to encompass any vehicle with a rear lift gate capable of supporting the inventive device. This includes, without limitation, automobile station wagons, vans, minivans, sports utility vehicles, and the like. Those skilled in the art will appreciate that the principles of the present invention may be readily applied to any vehicle having such a rear lift gate. For the sake of convenience these various vehicles will be referred to herein as an automobile.

The alcove provides the user with a protected area external to the automobile that may be used for a number of purposes. For example, the alcove may provide a changing room for snow or water activities. The alcove also conveniently provides an area to assemble or disassemble equipment. For example, the alcove may conveniently be used to provide a diver with an area to assemble scuba equipment, photographic equipment, and the like. In another example, the alcove provides a convenient location for a photographer, geologist, or other individual working in the field to assemble or disassemble their equipment.

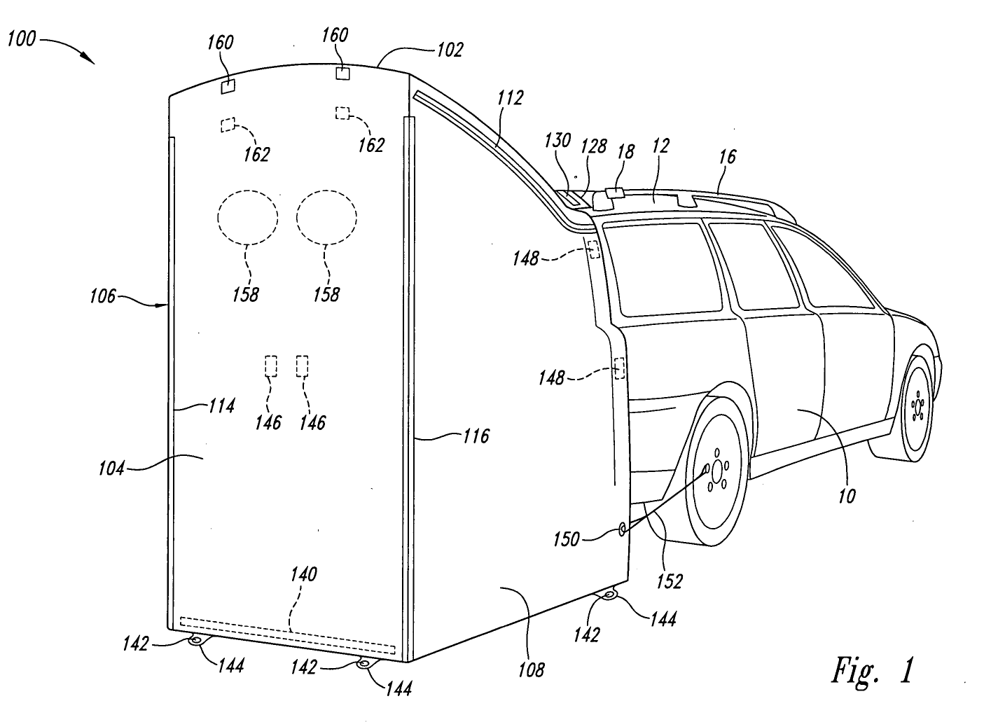

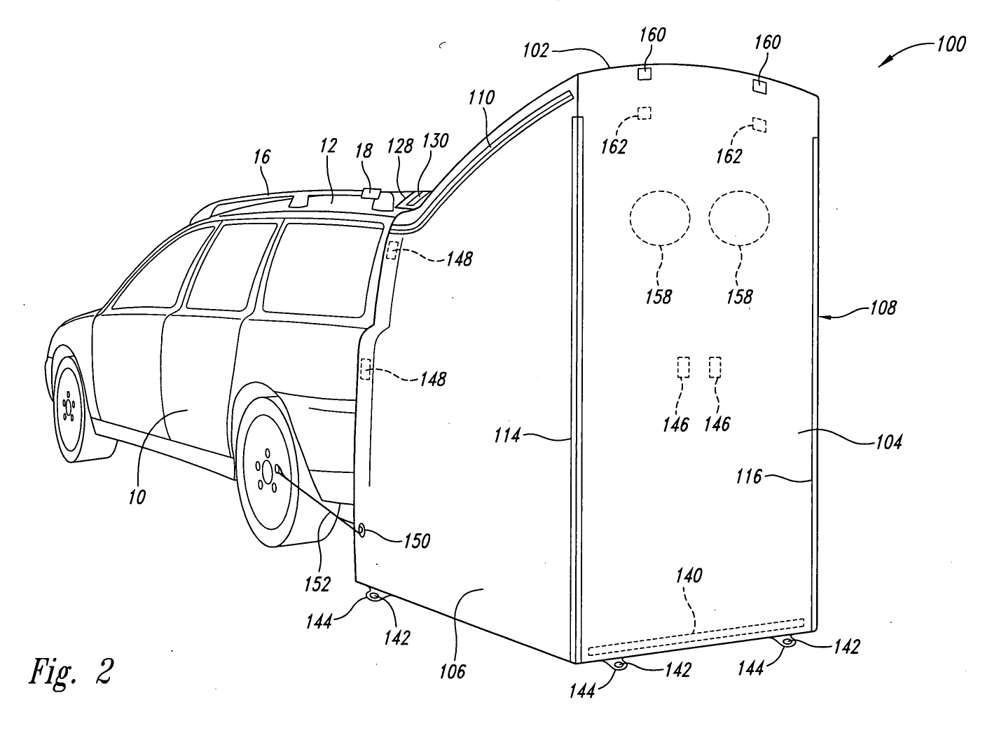

The alcove is shown in an exemplary embodiment of FIG. 1 as an apparatus 100. FIG. 1 is a passenger side perspective view that illustrates the apparatus 100 mounted on an automobile 10 in an open configuration. FIG. 2 is a driver side perspective of the apparatus 100 mounted on the automobile 10 in the open configuration. As seen in FIGS. 1-2, the apparatus 100 comprises a top panel 102, a rear panel 104, a left side (i.e., driver side) panel 106, and a right side (i.e., passenger side) panel 108. The panels (i.e., the top panel 102, rear panel 104, left side panel 106, and right side panel 108, may be readily formed by rip stop nylon. Although the lift gate 4 provides protection to the user, the panels may be formed by waterproof materials. The top panel 102 and rear panel 104 may be formed from a single continuous piece of material or by multiple pieces sewn together.

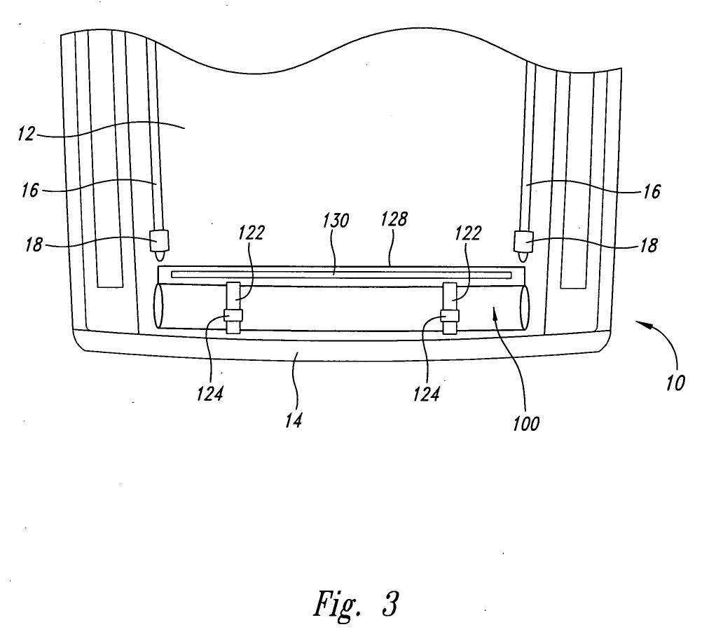

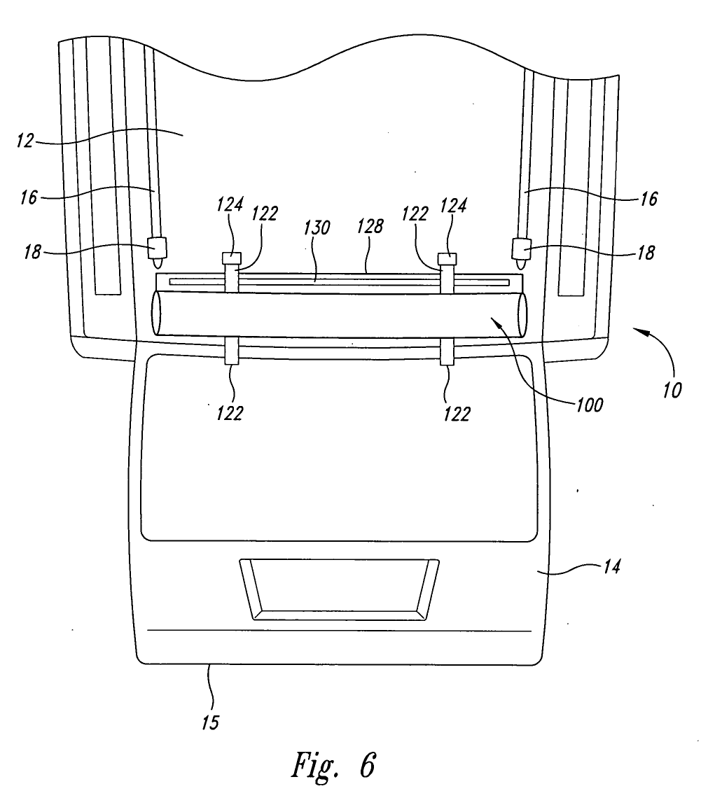

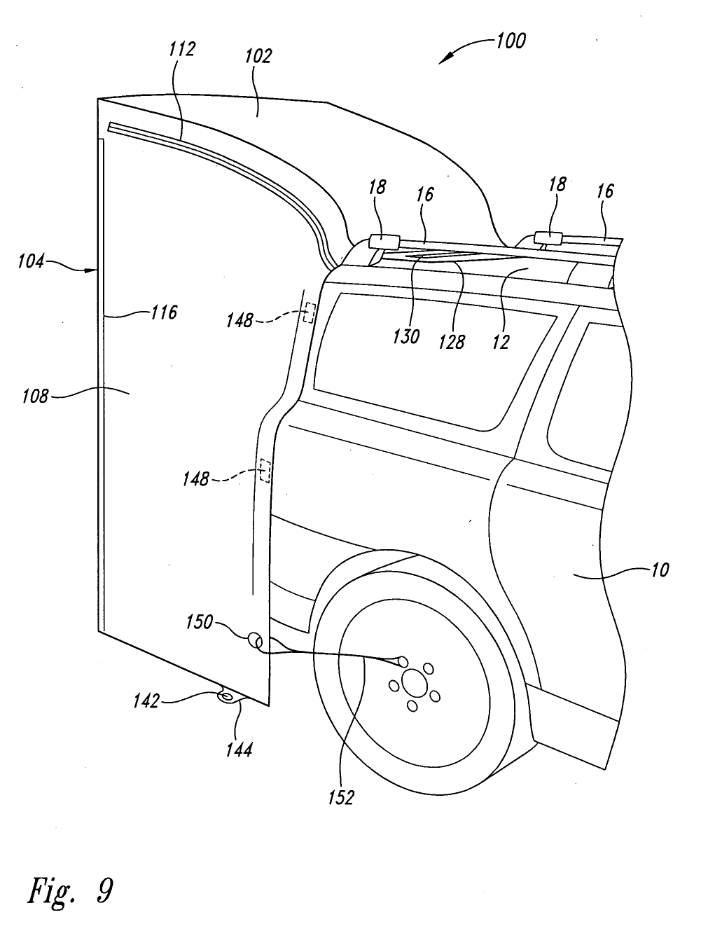

As will be described in greater detail below, the apparatus 100 is easily attached to a roof 12 of the automobile 10 in a region proximate a lift gate 14 (see FIG. 3). The lift gate 14 may then be opened (see FIG. 6) and the top panel 102 and rear panel 104 easily unfolded over the opened lift gate of the automobile 10. The left and right side panels 106-108 are then unfolded and coupled to the top panel 102 by a left side panel coupling member 110 (see FIG. 2) and a right side panel coupling member 112, respectively. In an exemplary embodiment, the left and right side panel coupling members 110-112 are zippers. In an exemplary embodiment, the top panel 102 may extend slightly beyond the width of the lift gate 14 and project downwardly. As best seen in FIG. 9, the right side panel coupling member 112 couples the right side panel 108 to the downwardly projecting portion of the top panel 102. This arrangement simplifies the process of zipping the right side panel 108 to the top panel 102. A similar arrangement is provided to allow the left side panel 106 to zip easily to the top panel 102, as shown in FIG. 2.

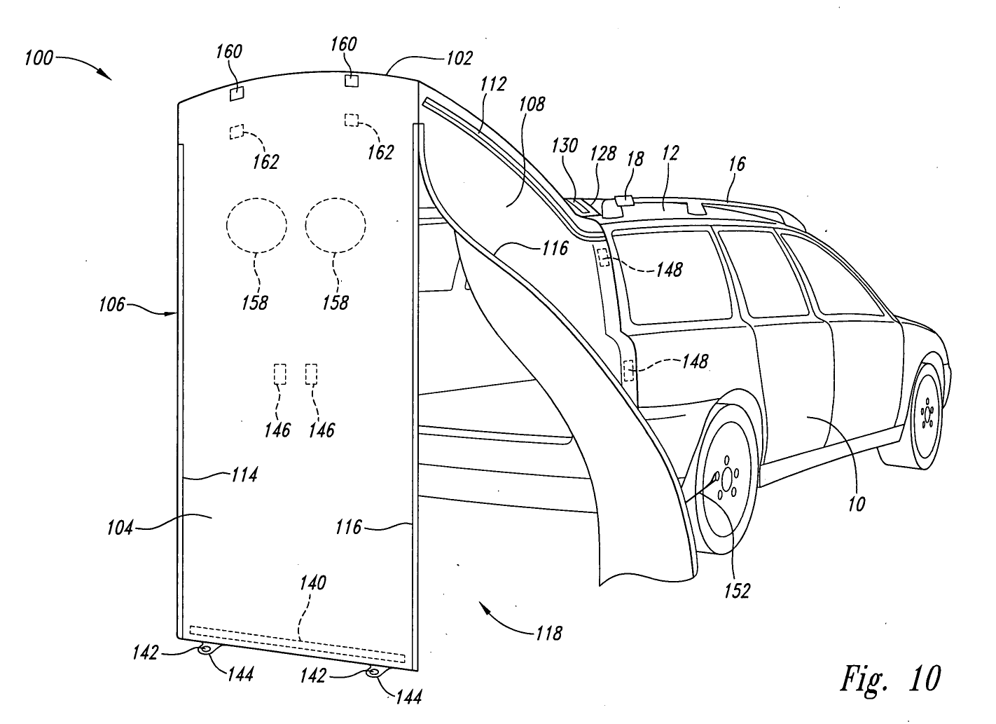

The apparatus 100 also comprises a left side closure mechanism 114 (see FIG. 2) and a right side closure mechanism 116. The closure mechanisms 114-116 allow access to an interior portion 118 (see FIG. 10) of the apparatus 100. One skilled in the art can appreciate that the apparatus 100 can be implemented with only one closure mechanism (i.e. either the left side closure mechanism 114 or the right side closure mechanism 116). Closure mechanisms on both the left and right side panels 106-108 allow greater flexibility for the user to enter or exit the interior portion 118. In an exemplary embodiment, the closure mechanisms 114-116 are zippers. Alternatively, the closure mechanisms 114-116 may be implemented with magnetic strips, Velcro, snaps, ties, or the like. The goal is to provide a convenient mechanism for entering or exiting the interior portion 118 in a convenient manner. Other known mechanisms may be used to implement to left and right side closure mechanisms 114-116.

The apparatus 100 may optionally include one or more view ports 158. While the view ports 158 are illustrated in FIGS. 1 and 2 as circular, those skilled in the art will appreciate that other suitable forms may be used. In an exemplary embodiment, the view ports 158 are implemented with flexible plastic material to enable flexing when the rear panel 104 is rolled up. Those skilled in the art will also appreciate that the view port 158 may be located in other positions, such as the left side panel 106 and/or the right side panel 108.

The operation of the apparatus and additional structural details may now be provided. FIG. 3 is a top plan fragmentary view of the rear of the automobile 10. Referring to FIG. 3, the apparatus 100 is placed on the roof 12 of the automobile 10 in a region just forward of the lift gate 14. Those skilled in the art will appreciate that the lift gate 14 is shown in FIG. 3 in the closed position. The lift gate 14 pivotally rotates on hinges (not shown) to an open position, as illustrated in FIG. 6. The apparatus 100 is illustrated in FIG. 3 in a closed configuration, which is useful for storage. Straps 122 are provided with terminal clips 124 to wrap around and maintain the apparatus 100 in the rolled up configuration. Although not essential to the apparatus 100, the straps 122 and clips 124 allow convenient storage of the apparatus in a rolled-up closed configuration. The rolled-up configuration also simplifies the deployment process, as will be described below. In an exemplary embodiment, the straps 122 may be sewn directly to the apparatus 100 to avoid misplacing the straps.

In operation, the rolled up apparatus 100 is placed on the roof 12 of the automobile 10 in a region just forward of the lift gate 14. A leading edge 128 of the top panel 102 is coupled to the roof 12 by a coupling member 130 and the clips 124 unsnapped to permit deployment of the apparatus 100. Coupling member 130 may be implemented using one or more of a variety of techniques. In an exemplary embodiment, the coupling member 130 is implemented using magnets to magnetically couple the leading edge 128 to the roof 12. The magnets may be implemented in the form of a magnetic strip, or a plurality of spaced-apart individual magnets. Alternatively, the coupling member 130 may be implemented using Velcro or snaps with one portion of the Velcro or snaps coupled directly to the roof 12 and the other mating portion of the Velcro or snap coupled to the leading edge 128. For example, boats often include a series of snaps along the perimeter to receive and retain a waterproof tarp. Similarly, the automobile 10 may include a series of snaps along the roof 12 just forward of the lift gate 14 to receive and retain the coupling member 130 in the form of mating snap connectors.

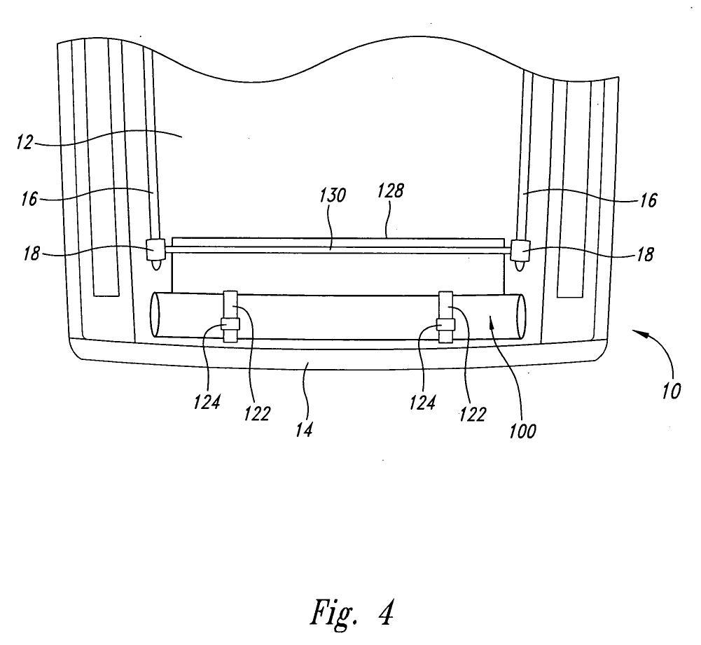

In an alternative embodiment, illustrated in FIG. 4, the leading edge 128 extends to a point between a roof rack 16. In this embodiment, the coupling member 130 may be implemented as an adjustable tension bar sized to fit between roof rack brackets 18 of the roof rack 16. The adjustable tension bar is adjusted to provide sufficient force directed outwardly against the roof rack brackets 18 to thereby frictionally maintain the leading edge 128 in a desired position on the roof 12.

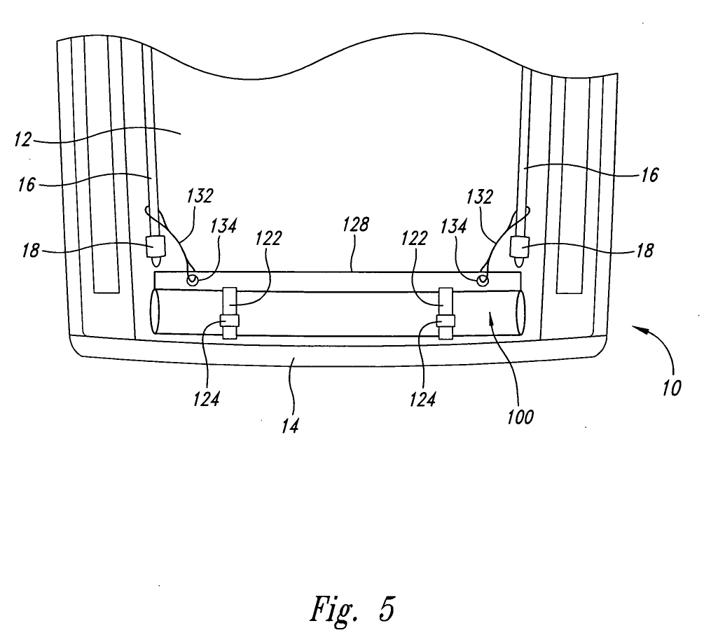

In yet another embodiment, illustrated in FIG. 5, the coupling member 130 may be replaced, or used in conjunction with resilient members 132, such as bungee cords or elastic-type material. The resilient members 132 are coupled at a first end to apertures 134 in the leading edge 128 of the top panel 102. The apertures 134 may include grommets or other known reinforcement elements. A second end of the resilient members 132 are coupled to the automobile 10 at a convenient location. For example, FIG. 5 illustrates the second end of the resilient members 132 coupled to the roof rack 16 or the roof rack brackets 18. Other alternative locations may be readily employed by stretching the resilient members 132 to a desired length.

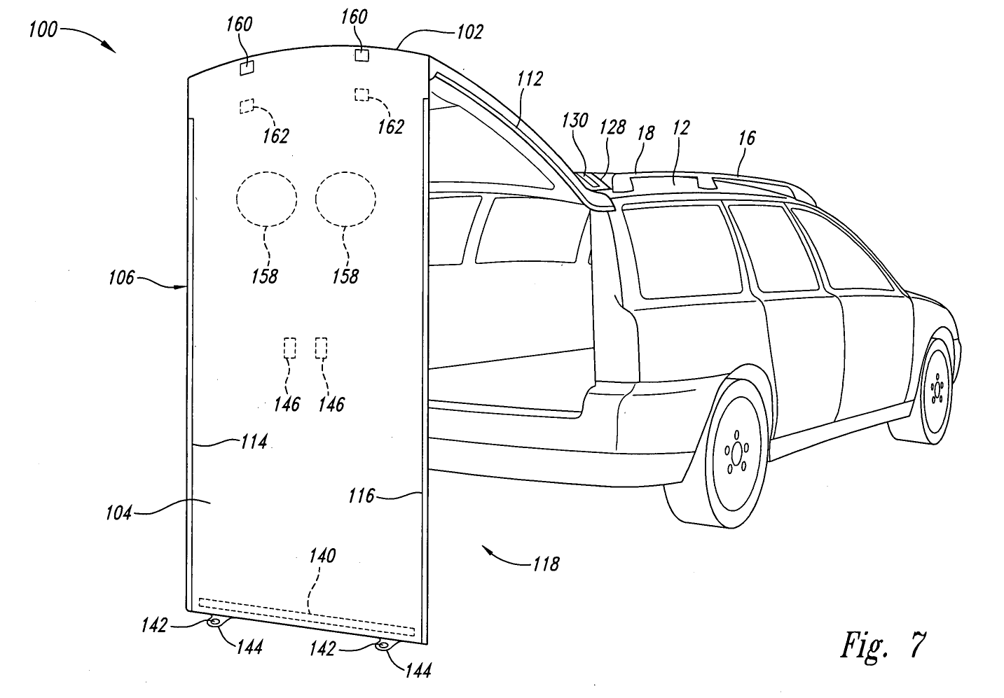

In operation, the leading edge 128 is mounted to the roof 12, as described above. The lift gate 14 of the automobile is then opened, as illustrated in FIG. 6, and the apparatus 100 unrolled from the pivoting end of the lift gate, near the roof 12, to a free end portion 15 of the lift gate. FIG. 7 illustrates the partially deployed apparatus with the top panel 102 extending over the free end portion 15 of the lift gate 14. The rear panel 104 extends downwardly from the free end portion 15 of the lift gate to a region proximate the ground. A weight 140 may be retained within a seam at a lower portion of the rear panel 104. The weight 140 assists in the deployment of the rear panel 104 and further serves to stabilize the rear panel during use. Alternatively, the rear panel 104 may include apertures 142 attached to a lower portion of the rear panel to permit stakes (not shown) to secure the rear panel during use. The apertures 142 may include grommets or other known reinforcement elements. In the embodiment illustrated in FIGS. 1, 2 and 7, the apertures 142 are positioned within tabs 144 extending from the rear panel 104. Other known mechanisms may be used to secure the rear panel 104 during use. For example, resilient members or other material may be coupled through the apertures 142 to secure the rear panel 104.

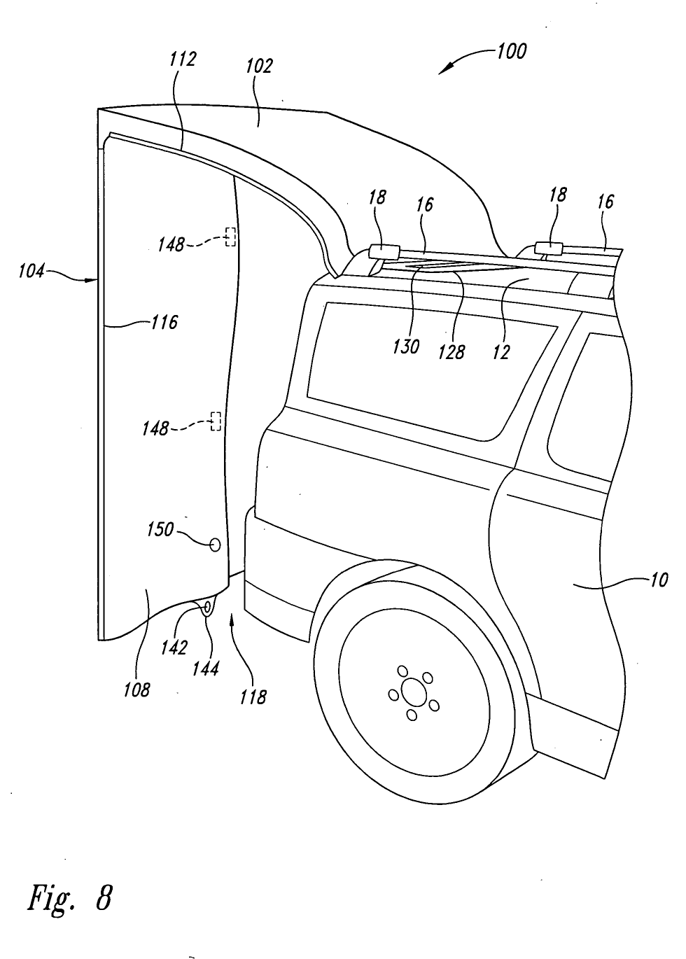

After the top panel 102 and rear panel 104 have been deployed, the left and right side panels 106-108 are unfolded and coupled to the top panel 102 using the left and right side panel coupling members 110-112, as previously described. FIG. 8 illustrates the folded configuration of the left and right side panels 106-108. For convenience in deployment, disassembly, and storage, the left and right side panels 106-108 fold up against the rear panel 104. During deployment, the left side panel 106 is unfolded and coupled to the top panel 102 using the left side panel coupling member 110 (see FIG. 2). Similarly, the right side panel 108 is unfolded and coupled to the top panel 102 using right side panel coupling member 112.

FIG. 9 illustrates the completely deployed apparatus 100. As best illustrated in FIG. 9, a leading edge of the right side panel 108 adjacent to the automobile 10 is coupled to the side of the automobile 10 by fasteners 148. In an exemplary embodiment, the fasteners 148 may be implemented using magnets to magnetically couple the adjacent edge of the right side panel 108 to the automobile 10. The right side panel may also be secured by way of a stake through the aperture 142 in the tab 144. The aperture 142 may receive a stake (not shown) directly or via an intermediate element, such as a rope or resilient member.

The adjacent edge of the right side panel 108 may also include an aperture 150 to allow additional attachment to the automobile 10. For example, a resilient member 152, such as a bungee cord, may be attached at a first end to the aperture 150 and attached at a second end to a wheel or wheel well or other attachment point on the automobile 10. Those skilled in the art will appreciate that a resilient member 152 may be replaced by an adjustable length cord or other suitable device. The resilient member 152 may also be coupled to a point away from the automobile 10 using, by way of example, a stake. The aperture 150 may include a grommet or other known reinforcing element.

Similarly, the edge of the left side panel 106 adjacent the automobile 10 is coupled to the automobile with fasteners 148, in the manner described above with respect to the right side panel 108. FIG. 2 illustrates the use of the fasteners 148 and the aperture 150 to couple the adjacent edge of the left side panel 106 to the automobile 10.

When the apparatus 100 has been assembled, ingress and egress form the interior portion 118 is accomplished by opening the left side closure mechanism 114 or the right side closure mechanism 116, as illustrated in FIG. 10. For example, if the right side closure mechanism 116 is a zipper, the user merely unzips the zipper (i.e., the right side closure mechanism 116) and pushes aside the right side panel 108. With the right side panel 108 in the open position, the user may easily enter or exit the interior portion 118, or move equipment in and out of the interior portion. To reseal the apparatus 100, the user simply closes the right side closure mechanism 116. An identical operation is performed with the left side closure mechanism 114 to enter or exit the apparatus by opening the left side panel 106. As noted above, the left and right closure mechanisms 114-116 may be implemented using a variety of known techniques.

In the embodiment of the apparatus 100 illustrated in FIGS. 1-10, disassembly of the apparatus is easily performed. Following the removal of any stakes or resilient members from the left and right side panels 106-108 (e.g., the resilient members 152), the left and right side panel coupling members 110-112 may be released. When implemented as a zipper, the right side panel coupling member 112 is unzipped allowing the user to release the fasteners 148 that couple the adjacent edge of the right side panel 108 to the automobile 10. The user simply folds in the right side panel 108 into the interior portion 118 (see FIG. 7.) In an exemplary embodiment, at least one the fasteners 148 engages a coupling fastener 146 installed on the rear panel 104. When the fasteners 148 is implemented as a magnet, the coupling fastener 146 may also be implemented as a magnet sewn into the rear panel 104. The magnets 146 and 148 are oriented to attract each other such that the fastener 148 in the right side panel 108 is received and magnetically retained by the coupling fastener 146 in the rear panel 104.

Similarly, the left side panel 106 is released from the automobile by removing the fasteners 148 and any other devices, such as the resilient members 152. The left side panel coupling member 110 is released and the left side panel 106 folded into the interior portion 118. The fastener 148 on the left side panel 106 is received and engaged by the corresponding coupling fastener 146 on the rear panel 104. Thus, the left and right side panels 106 and 108 easily fold up and are coupled to the rear panel 104. The apparatus, now partially disassembled, resembles the partially deployed configuration illustrated in FIG. 7.

Any retaining members, such as stakes through the apertures 142, are removed from the rear panel 104. The rear panel 104, along with the now folded left and right side panels 106 and 108 may be easily rolled up. To assist in the closing process, an upper portion of the rear panel 104 includes a pair of spaced-apart fasteners 160. In an exemplary embodiment, the spaced-apart fasteners 160 are mounted on the outer portion of the rear panel 104 while corresponding spaced apart coupling fasteners 162 are mounted on the interior portion of the rear panel 104 above the level of the folded left and right side panels 106-108. As the combination rear panel 104 and folded left and right side panels 106-108 are rolled up, the coupling fasteners 162 are exposed. As the rolling process continues, the coupling fasteners 162 engage and are retained by the fasteners 160. Thus, the rear panel 104 and folded left and right side panels 106-108 are temporarily maintained in a rolled-up configuration by virtue of the fasteners 160 and coupling fasteners 162. In an exemplary embodiment, the fasteners 160 and coupling fasteners 162 are two corresponding Velcro materials. However, other devices, such as magnets, may also be used. In another implementation, the fasteners 160 and coupling fasteners 162 may both be implemented as strings that the user may temporarily tie to assist in the removal process.

Upon completion of the rolling process involving the rear panel 104 and folded left and right side panels 106-108, the lift gate 14 is closed and the rolling process may be completed, thus returning the apparatus 100 to the closed configuration illustrated in FIG. 3. The straps 122 and clips 124 may be used to maintain the apparatus 100 in a furled configuration for removal and subsequent storage. The coupling member 130 may be released to thereby disengage the apparatus 100 from the automobile 10.

Thus, the apparatus 100 may be quickly set up or removed from the automobile 10 to provide the desired alcove/shelter. A number of different alternative fasteners and configurations have been described herein. Those skilled in the art will appreciate that other minor variations may be used without departing from the spirit of the invention.

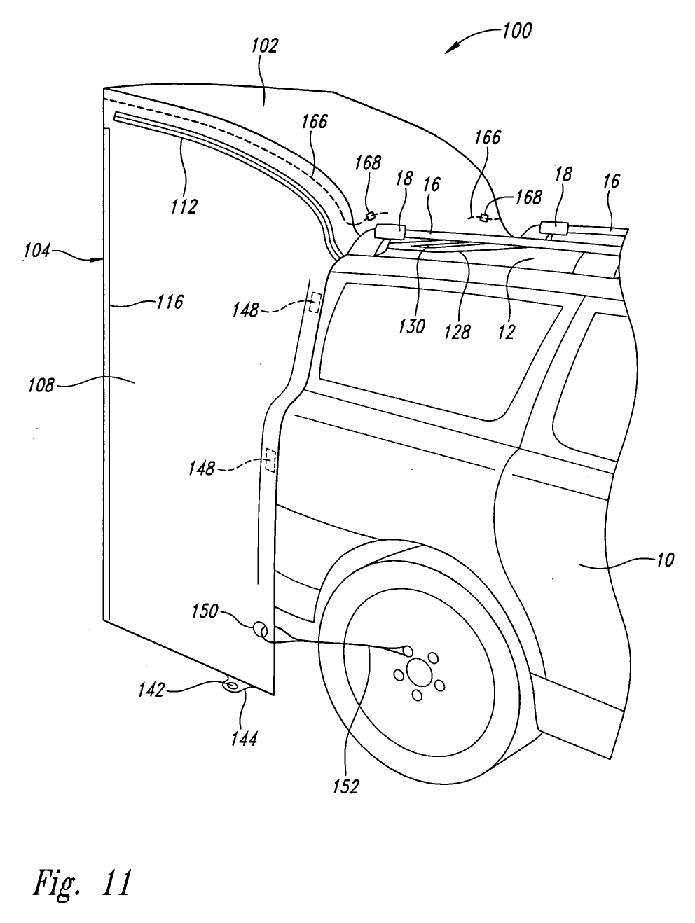

In one alternative embodiment, illustrated in FIG. 11, an adjustment mechanism 166 may be included in the top panel 102 to allow for variations in the width of the automobile 10 and thus variations in the width of the lift gate 14. The adjustment mechanism 166 may be used in conjunction with, or in place of the left and right side panel coupling members 110-112. In an exemplary embodiment, the adjustment mechanism 166 may be implemented as a drawstring embedded within the top panel 102. After the top panel is initially mounted on the open lift gate 114, the drawstrings may be adjusted by the user to provide the desired tightness of fit. Those skilled in the art will recognize that the drawstring may surround the entire perimeter of the top panel 102 or may be deployed along a portion of the perimeter of the top panel.

The adjustment mechanism 166 may also take the form of a resilient member, such as a “shock cord” commonly found in outdoor clothing and equipment. The resilient member functions in a manner similar to that of the drawstring described above. That is, the resilient member may be sewn into the top panel 102 and surround substantially the entire perimeter thereof or a portion of the perimeter of the top panel. The resilient member may be adjusted by the user through conventional means, such as a spring loaded clip 168, tied knot, or the like.

In yet another alternative embodiment, the adjustment mechanism 166 may comprise a resilient material, such as the elastic material, sewn into a portion of the top panel 102. This embodiment is configured somewhat like a fitted bed sheet, which is designed to accommodate mattresses of varying thicknesses and still provide a snug fit. In a similar fashion, the elastic implementation of the adjustment mechanism 166 allows the top panel 102 to be “fit” over the open lift gate 14 such that the elastic adjustment mechanism 166 fits snugly over the lift gate without any drawstrings or adjustments by the user.

The various alternative embodiments using the adjustment mechanism 166 may be used with or without the left and right side panel coupling members 110-112. If the left and right side coupling members 110-112 are eliminated, the left and right side panels 106-108 may be attached directly to the top panel 102. For example, the left and side panels 106-108 could be sewn to the top panel 102.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

The invention claimed is:

1. An automobile alcove apparatus for attachment to an automobile and support by a rear lift gate of the automobile, the lift gate having an end portion pivotally mounted to a rear portion of the automobile frame and a free-end portion, the apparatus comprising:
a top panel having a first edge for removable attachment to the automobile, the top panel extending in a first direction approximately the width of the lift gate, and extending in a second direction a distance approximately equal to a distance between the pivotally mounted end portion of the lift gate and the free-end portion of the lift gate;
a rear panel coupled to the top panel at a second edge opposite the first edge, the rear panel having a length extending downwardly to a location proximate the ground;
first and second opposing side panels each coupled to the top panel and the rear panel; and
a coupling member coupled to the top panel first edge and configured to be removably coupled to the automobile in an area proximate the lift gate of the automobile.

2. The apparatus of claim 1 wherein the coupling member is a magnetic strip fixedly coupled to the first edge and positioned for magnetic coupling to the automobile.

3. The apparatus of claim 1 wherein the coupling member comprises a first Velcro portion fixedly coupled to the first edge and a second Velcro portion positioned for removable coupling to the automobile.

4. The apparatus of claim 1 wherein the coupling member comprises a resilient member coupled to the first edge and configured for removable coupling to the automobile.

5. The apparatus of claim 1 wherein the coupling member comprises a snap coupled to the first edge and configured for removable coupling to the automobile.

6. The apparatus of claim 1 wherein the coupling member comprises a tension rod coupled to the first edge and configured for frictional coupling to the automobile.

7. The apparatus of claim 1, further comprising an adjustment mechanism coupled to the top panel and configured for adjustment by a user to adjust the top panel in at least the first direction to adjust to the width of the lift gate.

8. The apparatus of claim 7 wherein the adjustment mechanism comprises a resilient member coupled to the top panel, the resilient adjustment mechanism being configured for adjustment by the user to fit the top panel to the width of the lift gate.

9. The apparatus of claim 7 wherein the adjustment mechanism comprises a drawstring coupled to the top panel and adjustable by the user to fit the top panel to the width of the lift gate.

10. The apparatus of claim 1, further comprising a resilient member coupled to at least a portion of a perimeter of the top panel to permit the top panel to fit the lift gate.

11. The apparatus of claim 1 wherein the first edge is configured to couple to the automobile at a position on the rear portion of the automobile frame in front of the pivotally mounted portion of lift gate of the automobile.

12. The apparatus of claim 1, further comprising a view port.

13. The apparatus of claim 1, further comprising a closure mechanism coupling the rear panel to a selected one of the first and second side panels.

14. The apparatus of claim 13 wherein the closure mechanism is selected from a group of closure mechanisms comprising a zipper, magnetic coupling elements, Velcro coupling elements, and strap elements.

15. The apparatus of claim 1, further comprising a resilient member coupled to the top panel first edge and configured for resilient attachment to the automobile.

16. The apparatus of claim 15 wherein the resilient member is configured for resilient attachment to an automobile luggage rack.

17. The apparatus of claim 1, further comprising attachment members on the first and second side panels along an edge of the panels adjacent the automobile to removably couple the adjacent edge of the first and second side panels to the automobile.

18. The apparatus of claim 17 wherein the attachment members on the first and second side panels are magnetic members fixedly attached to the first and second side panels and positioned for magnetic attachment to the automobile.

19. The apparatus of claim 17 wherein the attachment members are resilient members coupled to the first and second side panels and positioned for resilient attachment to the automobile.

20. The apparatus of claim 1, further comprising a weighted member attached to the rear panel at a lower end thereof.

21. The apparatus of claim 1, further comprising at least a first aperture proximate the rear panel at a lower end thereof to thereby secure the rear panel.

22. The apparatus of claim 1 wherein the top panel and the rear panel are formed from a continuous piece of material.

23. The apparatus of claim 1 wherein the top panel, rear panel and side panels are formed from ripstop nylon.

24. The apparatus of claim 1 wherein the top panel has a width that extends beyond the lift gate width to form an upper portion of the first and second side panels, respectively.

25. The apparatus of claim 24, further comprising a closure mechanism to couple the first and second side panels to the top panel along edges of the top panel adjacent to the first edge.

26. A method for attaching an automobile alcove to a parked automobile having a rear lift gate, the lift gate having an end portion pivotally mounted to a rear portion of the automobile frame and a free-end portion, comprising:
removably attaching a top panel first edge to the automobile in a region proximate the pivotally mounted end portion of the lift gate;
extending the top panel over the lift gate while in an open position to permit a rear panel, coupled to the top panel, to extend downwardly from the free-end portion of the lift gate to a position proximate the surface on which the automobile is parked;
coupling a first side panel to the top panel along an edge of the top panel adjacent to the top panel first edge; and
coupling a second side panel opposite the first side panel to the top panel along an edge of the top panel adjacent to the top panel first edge and opposite the adjacent edge of the top panel to which the first side panel is coupled.

27. The method of claim 26, further comprising adjusting an adjustment member on the top panel to permit the top panel to fit a width of the lift gate.

28. The method of claim 26 wherein removably attaching the top panel first edge comprises magnetically coupling a magnetic strip fixedly coupled to the first edge to the automobile.

29. The method of claim 26 wherein removably attaching the top panel first edge comprises attaching the top panel first edge at a position on the rear portion of the automobile frame in front of the pivotally mounted portion of lift gate of the automobile.

30. The method of claim 26, further comprising coupling the rear panel to a selected one of the first and second side panels with a closure mechanism.

31. The method of claim 30 wherein the closure mechanism is a zipper and coupling the rear panel to the selected one of the first and second side panels comprises zipping the rear panel to the selected one of the first and second side panels.

32. The method of claim 26 wherein removably attaching the top panel first edge comprises coupling a resilient member between the top panel first edge and the automobile.

33. The method of claim 26, further comprising removably attaching the first and second side panels along an edge of the panels adjacent the automobile to removably couple the adjacent edge of the first and second side panels to the automobile.

34. The method of claim 33 wherein removably attaching the first and second side panels comprises magnetically coupling the adjacent edge of the first and second side panels to the automobile.

35. The method of claim 33 wherein removably attaching the first and second side panels comprises coupling resilient members between the first and second side panels and an automobile wheel.

36. The method of claim 26 wherein extending the rear panel downwardly comprises unfurling the rear panel using a weighted member attached to the rear panel at a lower end thereof.

37. The method of claim 26 wherein coupling the first and second side panels to the top panel along edges of the top panel adjacent to the first edge comprises zipping the first and second side panels to the top panel.

38. The method of claim 26, further comprising removing the automobile alcove by:
uncoupling the first and second side panels from the top;
furling the rear panel;
furling the top panel; and
removing the automobile alcove from the lift gate.

39. The method of claim 38, further comprising coupling the first and second side panels to the rear panel along after uncoupling from the top panel wherein furling the rear panel also includes furling the first and second side panels coupled to the rear panel.

40. The method of claim 39 wherein the rear panel contains embedded magnets in predetermined locations and the first and second side panels each contain embedded magnets in locations corresponding to the locations of the embedded magnets in the rear panel when the first and second panels are folded onto the rear panel and coupling the first and second side panels to the rear panel comprises folding the first panel over the rear panel to magnetically couple the embedded magnet in the first side panel to the embedded magnet in the rear panel and folding the second panel over the rear panel to magnetically couple the embedded magnet in the second side panel to the embedded magnet in the rear panel.
